(19) United States
(12) Patent Application Publication
(10) Pub. No.: US 2023/0115964 A1
(43) Pub. Date: Apr. 13, 2023

(54) FAST REPLICATION OF LASER MACHINED MICRON/SUB-MICRON SCALE PATTERNS ONTO SOFT-METAL SUBSTRATES VIA EMBOSSING

(71) Applicant: University of Ottawa, Ottawa (CA)

(72) Inventors: Arnaud Weck, Ottawa (CA); Xitong Xie, Ottawa (CA); Jaspreet Walia, Ottawa (CA)

(21) Appl. No.: 17/899,230

(22) Filed: Aug. 30, 2022

Related U.S. Application Data
(60) Provisional application No. 63/238,665, filed on Aug. 30, 2021.

(51) Int. Cl. B21D 37/20; B23K 26/364; G01B 11/02

(52) U.S. Cl. CPC B21D 37/20; B23K 26/364; G01B 11/026

(57) ABSTRACT

Systems and methods described for embossing micro-scale features are provided. On various substrates. Micro-scaled features can contain nanometer to micrometer structural features. Various embodiments may relate to methods and systems that may allow substrates, non-limiting examples of which may include metals such as silver, copper, tin, gold, or the like, to be embossed to diffract light into various colors that can be refracted at various perspective angles. High-quality grooves can be machined down to the sub-micron or nanometer regime to generate embossment moulds for fast, single-step, repeated (e.g. in the order of tens to thousands) replication of gratings on bulk metallic substrates using a same embossing die without significant loss of embossing quality.

### CROSS-REFERENCE TO RELATED APPLICATIONS

The present application claims priority from U.S. Provisional Patent Application No. 63/238,665 Filed Aug. 30, 2021, the entirety of which is hereby incorporated by reference for all purposes.

### TECHNICAL FIELD

The present disclosure relates to embossing, and, in particular, to a metal embossing system and method for creating a die and embossing micro-scaled surface features on soft metal substrates.

### BACKGROUND

Recent decades have seen the emergence of laser beams with femtosecond pulse durations, enabling extremely high light intensities, which, in combination with tight focusing, may be used for precise cutting and micromachining. Such technology can be used, either directly or in combination with embossing techniques, to produce nano- or micro-structured surface features such as gratings capable of diffracting light to produce optical colors.

For instance, U.S. Pat. No. 8,336,361 entitled “Embossing method and apparatus for producing diffraction-active structures” and issued Dec. 25, 2012 to Fahrenbach discloses a system and method for embossing both micro- and macrostructures on a coin by applying a protective coating to a surface between stamping steps.

U.S. Pat. No. 9,140,834 entitled “Method and device for producing color pattern by means of diffraction gratings” and issued Sep. 22, 2015 to Boegli discloses a pico- to femtosecond pulse laser system operable to generate rippled structures on a solid body, wherein the solid body can then be used to emboss diffraction gratings on decorative objects such as packaging foils to produce colors.

International Patent Application No. 2004/045866 entitled “Nano-optical color embossing” published Jun. 3, 2004 to Fellenberg and Fahrenbach discloses a method of generating a diamond or quartz master stamp that may be used to produce other embossment dies capable of embossing microscale pattern on metallic substrates.

The quality of the nano- or micro-structured surface features in the embossing process is dependent on the quality of the stamping features provided on the die. Ensuring the quality and consistency of the embossed product, such as a coin, is dependent on the quality of stamping die. Utilizing nano- or micro-structured surface features presents challenges in the manufacturing of a durable consistent die.

Accordingly, systems and methods that enable a die for repeated embossing of micro-scaled surface features remains highly desirable.

### BRIEF DESCRIPTION OF THE DRAWINGS

Further features and advantages of the present disclosure will become apparent from the following detailed description, taken in combination with the appended drawings, in which:

FIG. 1 shows an example of an embossing process;

FIG. 2 shows a system for die manufacturing;

FIG. 3 shows an illustration of displacement determination between laser focus and point sensor focus;

FIG. 4 shows a calibration structure;

FIG. 5 shows a scanned surface profile;

FIG. 6 shows optical microscope images of various laser-machined surfaces;

FIG. 7 shows scanning electron microscope images of substrate adhesion on various die surfaces;

FIG. 8 shows scanning electron microscope images of silver substrates embossed with dies fabricated using various laser machining parameters;

FIG. 9 shows optical images of various embossed substrates;

FIG. 10 shows SEM images of embossed gratings of various orientations before and after adding a quarter-wave plate in the laser path during machining;

FIG. 11 is an optical image of an 18-sides wheel pattern embossed in various substrates;

FIG. 12 is a plot of the diffraction efficiency versus applied stress for a pattern embossed in various substrates;

FIG. 13 shows diffraction patterns of the substrates comprising a series of dots arranged in a line perpendicular to a groove orientation;

FIGS. 14A and 14B are optical images of a substrate embossed with three grating patterns oriented in respective directions;

FIG. 15 shows optical images of arbitrary patterns embossed in copper and aluminum, respectively;

FIG. 16A is an optical image of a laser-machined die (left) and a silver substrate (right) embossed therewith, and FIGS. 16B to 16E are, on the left, upper right, and lower right panels, respectively, SEM images, AFM images, and averaged line scans of a die (FIG. 16B), and silver (FIG. 16C), copper (FIG. 16D), and aluminum (FIG. 16E) substrates embossed with the die of FIG. 16B;

FIG. 17 is an AFM image of sub-micron features transferred to a silver substrate (top), and the corresponding averaged line scan (bottom);

FIGS. 18A and 18B show optical images of a steel die and various substrates embossed therewith;

FIGS. 19A and 19B are optical images of substrates embossed with an 18-sides wheel pattern;

FIG. 20A shows an optical image of a diffraction pattern produced from laser light, and FIG. 20B is an image of the grating array used to produce the diffraction pattern of FIG. 20A;

FIGS. 21A and 21B are images of diffraction patterns produced from laser light diffracting off gratings arrays in a die and embossed silver substrate;

FIG. 22 shows a method of embossing micro-scaled surface features;

FIG. 23 shows a method of determining laser machining parameters; and

FIG. 24 shows a method of determining embossing parameters.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

One general aspect includes a method of fast replication of laser machined micron/sub-micron scale patterns onto soft-metal substrates via embossing. The method of fast replication of laser machined micron/sub also includes laser machining of the die to engrave grooves; pre-flattening of the substrate using two blank dies with a pre-flattening load, and embossing of the substrate using the laser machined die and a blank die with an embossing load. Other embodiments of this aspect include corresponding computer systems, apparatus, and computer programs recorded on one or more computer storage devices, each configured to perform the actions of the methods.

Implementations may include one or more of the following features. The method may include preparing the substrate by pre-flattening by applying a load that deforms the substrate material to obtain desired thickness and size and improve the surface smoothness. The method may include determining the proper embossing load at about 10 to 30 percent less than the pre-flattening load, depending on the substrate material and the scale of the patterns. The method may include determining laser machining parameters associated with a laser for embossing the material and the die material composition, obtaining a surface profile of the die material, generating a pattern design for application to the die material applying the obtained surface profile, and laser machining the die material with the generated pattern design. The method may include processing the die to removed redeposited material. The method may include embossing of metal with the die. Obtaining the surface profile a point sensor is utilized to map the profile of the die material. A displacement in the x-axis and y-axis between the point sensor and the laser are determined to calibrate the surface profile. Determining laser machining parameters further may include: determining a groove geometry associated with the pattern design, determining a range of laser fluence, performing a machining test using the determine parameters, and determining optimal laser machining parameters from the machining test. The surface profile is obtained in a z-axis. Implementations of the described techniques may include hardware, a method or process, or computer software on a computer-accessible medium.

One general aspect includes a system that also includes a laser; a point sensor; a computer numerical control (CNC) motion-controlled platform coupling the laser and point sensor; and a controller coupled to the laser, point sensor and CNC platform. Other embodiments of this aspect include corresponding computer systems, apparatus, and computer programs recorded on one or more computer storage devices, each configured to perform the actions of the methods.

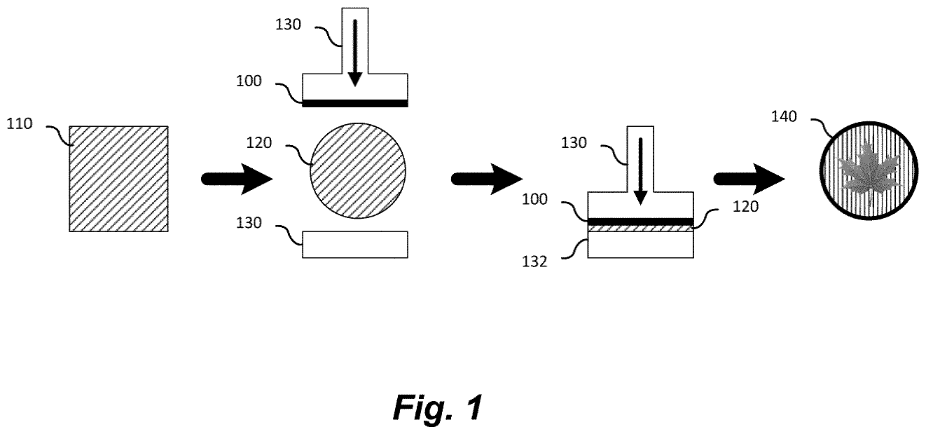

Embodiments are described below, by way of example only, with reference to FIGS. 1-24.

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

The terms “features” and “embossed features”, as interchangeably used herein will be understood to mean any geometrical feature that may be embossed or transferred to a substrate. While examples of features herein described may refer to “gratings” or “diffraction gratings”, the scope of features that may be machined, embossed, or transferred within the scope of the disclosure are not so limited, and may include, for instance, other geometrical features such as lines, circles, gradients, complex images such as those obtained from a picture, and the like. In accordance with various embodiments, a feature may be one that produces an optical effect, such as one which imparts a substrate surface color, or produces distinct reflection and/or diffraction effects.

The terms “grating” and “diffraction grating” as interchangeably used herein will be understood to mean a structural feature or array of structural features on the surface of a substrate that is operable to diffract incident light to result in various colors at various angles. A grating may comprise periodic surface features, or may comprise variable feature dimensions and/or inter-feature spacing (e.g. a gradient grating). In accordance with various embodiments, spacing between features, or the dimensions of the features themselves, may be approximately (e.g. on the order of) a wavelength of incident or diffracted light. Accordingly, such features, as described herein, may be characterized as micro-scaled in that design aspects of such features can be defined by sizes, spacing and/or dimension in the order of micrometers, namely ranging from a few hundred nanometers to a few microns (e.g. 100 nm to 10 μm, to manifest optical properties anywhere within the optical spectrum from UV to IR). Features and/or gratings may be oriented in one or more dimensions. For instance, a grating may be one-dimensional, comprising like-oriented grooves along a substrate surface, or may comprise a two-dimensional grid of surface features. Furthermore, multiple gratings may be embossed on a single substrate, wherein different gratings may have similar or different physical and/or optical properties depending on the desired effect. A grating may be embossed before, after, or simultaneously with, other surface features (e.g. macroscopic features, other micro- or nanoscopic features, other gratings, or the like), or may comprise the sole feature embossed on a substrate.

The term “substrate” as used herein will be understood to mean a material that may be embossed. Various non-limiting examples of substrates may be a metal, alloy, polymer, or the like. In accordance with some embodiments, a substrate may comprise a coin or other form of currency (e.g. bullion coin, circulation coin), or precursor thereof.

Moreover, a substrate may be a flat or curved surface at one or more of before or after embossing. Furthermore, in accordance with various embodiments, a substrate may comprise a bulk material, or a bulk metal. In comparison with other substrates embossed with conventional systems, such as a thin film, a foil, a metal foil, glass, ornamental piece, or the like, bulk metals may be less amenable to conventional embossing on an industrial scale, particularly when a feature to be embossed is very small (i.e. micro-scaled, e.g. micron or sub-micron), as the precision required to do so and/or the amount of substrate deformation relative to the size of a feature may result in die degradation in a limited number of stamping attempts due to, for instance, substrate adhesion to a die or shim.

The terms “emboss” and “transfer” as interchangeably used herein will be understood to mean a process of transferring a feature to a substrate via stamping, or deforming a substrate with a hard material comprising a negative three-dimensional image of that to be embossed, through the application of a pressure, stress, or load. While conventional systems may emboss using shims, or other relatively cost-effective means of imparting a pattern to a substrate, such systems may lack the precision and/or durability required for repeatedly producing small-scale features (e.g. micron or sub-micron). Thus, additionally, or alternatively, various embodiments herein described may relate to embossing that employs a die for direct embossing of features on a substrate.

The systems and methods described herein provide, in accordance with different embodiments, different examples related to the embossment of various substrates with very small (micro-scaled, e.g. nanometer to micrometer) structural features. Various embodiments may relate to methods and systems that may allow substrates, non-limiting examples of which may include metals such as silver, copper, tin, gold, or the like, to be embossed in ambient conditions with structural features designed to diffract light into various colors. In accordance with some embodiments, colors may be refracted at various perspective angles. Various aspects may further relate to machining high-quality grooves down to the sub-micron or nanometer regime to generate embossment moulds for fast, single-step, repeated (e.g. in the order of tens to thousands) replication of gratings on bulk metallic substrates using a same embossing die without significant loss of embossing quality (e.g. consistently transferring a micro-scaled pattern without significant or prohibitive degradation of an intended optical property or manifestation of this pattern once transferred).

With reference to FIG. 1, embossing may be of use in minting and/or the production of currency. In the minting process a stamping material 110, comprising an alloy or metal such as but not limited to copper, silver, or gold, platinum or palladium forms a circular blank 120 which is placed in a minting press 130. The minting press 130 has a die 100 which is used to emboss the blank 120 with a design or image. The die 100 is pressed into the blank 110 by a tonnage appropriate for the type of stamping material to transfer features of the die 100. The micro features of the die 100 are transferred resulting in a finished coin 140. Where existing methods typically suffer from the drawbacks of, for instance, low yields, poor resultant grating quality, and/or a limited number of embossments that can be performed using an embossing tool (or die) before quality degrades to an extent that it can no longer be used for sensitive applications. In particular, reproducing grating of sufficient quality to be used as, for instance, an anti-counterfeiting measure, with a robust method of embossing in which the same die can be employed repeatedly to emboss many substrates (and therefore enable industrial-scale embossing of, for instance, coins), remains a challenge. As such, the systems and methods herein disclosed may additionally contribute to the production of currency that is difficult and/or prohibitively costly to counterfeit due to the high quality of fine-structure embossing at an industry scale, as herein enabled.

In accordance with various embodiments, patterns may optionally be “coded” such that a die or substrate need to be illuminated at a designated angle using a designated laser light wavelength. This may be useful in, for instance, increasing the difficulty associated with producing a counterfeit coin. Furthermore, variations in line spacing between different micro-gratings may be as small as several nanometers, potentially requiring a well-controlled environment, which may further restrict the production of counterfeit substrates such as coins.

Small features may be embossed on substrates that may reflect light. For instance, surface geometries may be precisely embossed so as to produce specific reflection patterns. Such embodiments may be useful in a range of applications, a non-limiting example of which may be an anti-counterfeiting measure in currency production.

Embossment of various features may occur during different embossing steps. For instance, in addition to the simultaneous embossment of a plurality of features, embossing of a microscale feature may be performed before or after embossment of another microscale or macroscale pattern or feature. A non-limiting example of such an embodiment may comprise a first embossment of a macroscale feature (e.g. an image of the Queen Victoria II) on a coin for Canadian circulation, followed by an embossment of a grating array operable to produce a specific diffraction pattern that may serve as an anti-counterfeiting measure. In such an embodiment, a stamping step prior to micro- or nano-embossing may, in accordance with some embodiments, pre-flatten a substrate, or otherwise deform the substrate to provide conditions that minimise, for instance, substrate removal, or other another effect that may degrade a die quality for subsequent embossments, or otherwise limit the lifetime or effective life cycle of a die. Similarly, a first embossment may allow for deformation of the substrate along a designated path, thereby improving subsequent embossments.

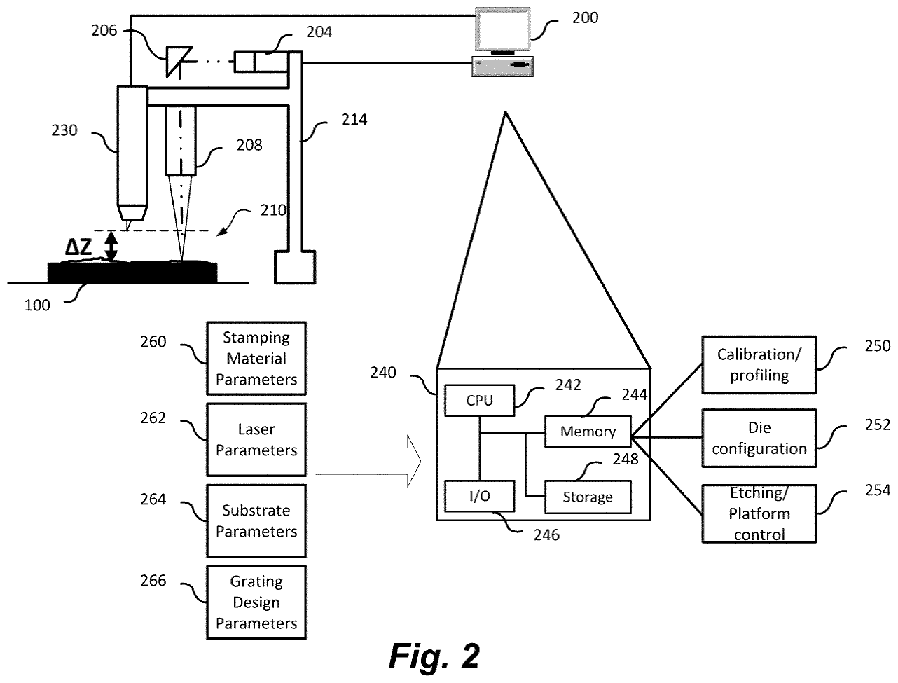

FIG. 2 shows a system for die manufacturing. The die material 100, from which the die is to be created, is profiled by a processing system 200 to determine the surface structure and enable engraving of the die material to create the die. The system 200 is coupled to a laser source 202 which can focus through and objective 208, either directed or via a mirror 206. A chromatic confocal point sensor 230 is utilized to profile the surface 210 of the die material 100 prior to etching the die. The term etching can be used synonymously with machining, engraving or texture of the die. The objective 208 and point sensor 230 are coupled to a 3-D computer numerical control (CNC) motion-controlled platform 214 providing control of movement in the X, Y and Z directions in a range for example of ±55 mm. The resolution of the CNC platform 214 may provide different movement accuracy dependent on the controllers utilized. For example in the X and Y direction 110 mm of travel may be provided with an accuracy of ±300 nm, while the Z direction can provide 5 mm of travel with an accuracy of ±200 nm to provide an accurate surface scan for laser etching. The movement of the stage is controlled by motion controller software. The software operates according to CNC programming language such as G-code programs. The confocal point sensor 230 is an ultra-precise displacement measuring system. Each system is comprised of an optoelectronic controller, an optical pen, and a fiber-optic connection cable. The controller houses the white light source, hardware for signal processing and Ethernet communications. The point sensor is a non-contact measurement probe which focuses the emitted light and collects the reflected signal for transmission, via optical fibers, to the controller. A point sensor 230 capable of 400 μm measuring range can be utilized, such as for example the STIL CL2-MG140. There will be displacements between the laser focus and the point sensor focus. The measurements of these displacements should be as precise as possible, to improve the accuracy of the surface profile scan.

The system 200 comprises one or more processors 242, coupled to a memory 244 containing instructions for calibrating/profiling 250, die configuration parameters 252 and etching 254 modules. The functions may be provided by one or more modules either combined or configured independently. An input/output 246 interface controls the laser 204 and/or point sensor 230, data access and user interaction with the system 200. A storage device 248 contains non-volatile memory containing instructions for providing function stored in memory 244. The system 200 can receive or utilize parameters as input for profiling and determining optimal parameters for etching the die material 100. Parameters may be such as, but not limited to, stamping material parameters 260, laser configuration parameters 262, die material parameters used for manufacturing the die 264, and the grating design parameters 266 which define the structure of design and desired effects from the end product. Once the die material 100 is profiled, the surface profile 210 is used to modify the design profile code in the ΔZ position to provide consistent die results and the desired optical properties.

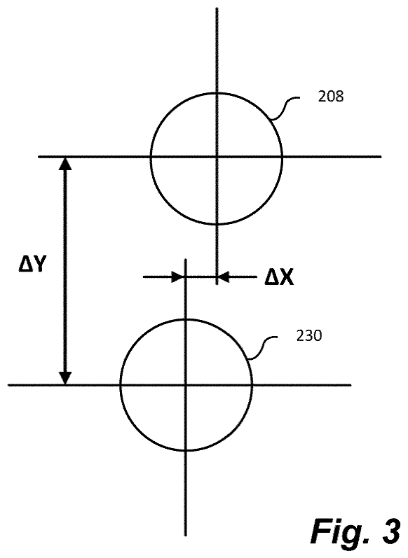

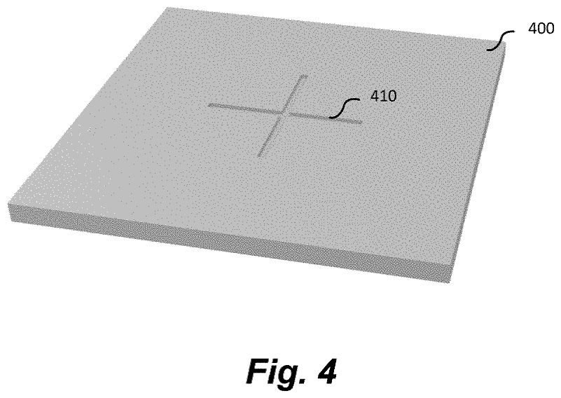

FIG. 3 shows an illustration of displacement determination between laser focus and point sensor focus. In order to provide an accurate profile the displacement between the laser focus 208 and the point sensor 230 focus must be determined for calibration by using a calibration structure 400, such as, as shown in FIG. 4. There will be displacements between the laser focus and the point sensor focus. The measurements of these displacements should be as precise as possible, to improve the accuracy of the surface profile scan. The indication of the displacements is given in FIG. 3, and a suggested structure for calibrating the displacements is shown for the X and Y axes.

The length of the two lines should be long enough, which will make it easier to quickly locate the pattern. The width of the lines should be narrow enough (for example, a few microns) to improve the measurement accuracy. Firstly, the center of the cross 410 is precisely at the laser focus, and X1 and Y1 and Z1 are determined by the system.

The sample under the chromatic confocal point sensor height (Z) is determined at the working distance of the point sensor, as is shown in FIG. 2.

The X of the sample is adjusted until an abrupt Z distance change happens, to determine X2. The process is repeated for Y and get Y2. The displacements between the two focuses are then obtained as ΔX=X1−X2, ΔY=Y1−Y2 and ΔZ=Z1−Z2.

The structure of FIG. 4 can be easily obtained by laser machining two lines on a polished die surface. The depth of the laser machined grooves can be very shallow compared to the range of the sensor, but their reflectance is much lower (because of the roughness, oxidation and difference in height), providing for calibration of the point sensor.

If the laser is precisely focused, and the laser fluence is high enough, the effect of the polarization can be neglected. When laser machining nano-scale features with extremely low laser fluence, or laser machining with slightly off focused laser (less deep, more uniform), there will be ripples forming on the edge of or within the grooves, it will affect the transfer (along/perpendicular better/worse). In those cases, a circular polarizer, or a rotating linear polarizer can be utilized.

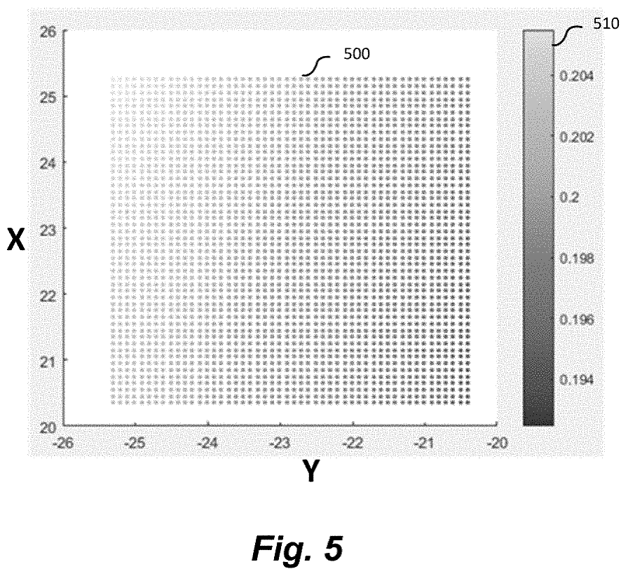

Once the point sensor is calibrated, a scanned surface profile 500 can be generated as shown in FIG. 5 defining the depth 510 variations of the die material. The scan starts from the corner of a square area, which has the minimum X and Y coordinate parameters. The scanning results will be stored in a CAL file, which is then used as a calibration of the height of the Z stage to maintain in-focus state during laser machining. The calibration file can then be applied to the die design to provide a consistent profile to the die and provide consistent embossing results. The point sensor scanning parameters can be adjusted according to the laser machined surface and requirements. For example, if the die surface is smooth and flat, the scanning step can be larger (0.25 mm); if the die surface is not flat, or has a macroscale pattern already, then use a smaller scanning step (0.1 mm or less) to capture as much details as possible.

In recent decades, laser surface texturing of different material surfaces for functionalization has been reported. Common laser machining technologies include laser induced periodic surface structure (LIPSS), direct laser interference patterning (DLIP), and direct laser writing (DLW).

LIPSS, often characterised by quasi-periodic linear ripples, are formed from irradiation of a material surface with polarised laser irradiation. The orientation of the ripples is determined by the polarisation of the incident beam, while the spatial period is controlled by the wavelength of the laser used. LIPSS have been created on different kinds of metals, including copper, aluminum and steel, producing colorful optical effects. Colors can be tuned by changing laser pulse energy, polarization, and spot size. However, machined LIPPS often show imperfect (discontinuous) ripples, resulting in low diffraction efficiencies and thus color intensities. Furthermore, the ripples produced by this technology are fragile, and are thus not easily accommodated by metalworking methods such as stamping. For LIPSS, the grating spacing cannot be changed easily and gradients are more difficult to create.

DLIP relies on the interference of two or more coherent laser beams that overlap to produce an interference pattern consisting of periodic modulations of light intensity which result in line-like or hole-like array patterns. For instance, DLIP may be employed to produce gradient gratings as single-colored decorating elements on a large area on stainless steel. With DLIP, the spatial period may be controlled by varying the angle between incident beams, and diffraction efficiency may be tuned by varying laser machining parameters such as laser fluence and pulse number. However, the line spacing range with such technology is often restricted by incident beam wavelength and the angle between beams. Moreover, the laser spot size applied in this method is typically tens of microns, limiting resolution and ultimately the size of the features that can be achieved.

DLW employs a focusing objective to obtain a small laser spot to directly engrave structures on a material surface. Combined with ultrashort pulsed lasers, which may have a very small (e.g. nanometers) heat-affected zone, DLW is a promising technology for fabricating diffraction grating moulds with high precision. Although DLW takes a relatively long time to machine samples, the laser-machined surfaces may be of high quality. For example, the edges of machined grooves may be smooth, and the shape of machined patterns well defined. Although long machining time is not an issue as the die is utilized to emboss tens of thousands of samples. Accordingly, in some embodiments, as will be described in greater detail below, DLW was considered as an option in machining an embossing die subsequently used to emboss a bulk metal surface.

For instance, various approaches to embossing small features on bulk rigid materials such as copper, aluminum, ultrafine grained aluminum, coarse grained aluminum, gold, and stainless steel have been disclosed. However, such studies have typically been able to successfully transfer only relatively large micron-sized features. Furthermore, such work has employed processes that require long times and/or high temperatures to be effective and are thus not practical for industrial applications where high replication speeds may be required. Moreover, no processes have been shown to have highly repeatable stamping of micron to sub-micron features with a single die at room temperature, presumably due to the inherent challenges associated therewith which typically results in rapid die degradation (i.e. a short duty cycle is required to have a high-quality transfer of small features during embossing).

As such, various embodiments of this disclosure relate to systems and methods that employ, sometimes in combination, aspects of ultrafast laser machining and embossing. Various aspects further relate to embossing at room temperature, and/or embossing that enables micron and sub-micron feature transfer to industrially relevant materials at high speeds, in a single step, using the same die for many stamps and/or strikes.

Furthermore, various embodiments of the disclosure relate to a system and method for creating high-resolution patterns on material surfaces from embossing. In accordance with various embodiments, tools used for embossing may be produced using ultrafast laser machining at high speed in a single step. The skilled artisan will appreciate that while various machining parameters are herein discussed, these are exemplary embodiments, only, and other parameters may be used without departing from the scope of the disclosure. Moreover, various aspects relate to methods and systems for achieving a high diffraction efficiency and transfer quality in embossed patterns. While various examples herein described relate to particular embossed patterns on metallic materials used in the coining and marking industry, such as copper, silver, or aluminum, the scope is similarly not limited to such patterns and/or materials.

Various non-limiting examples herein described relate to embossing using a tool steel mould, although other suitable mould (or die) materials may be used within the scope of the methods and systems herein disclosed. Moulds in such non-limiting embodiments may be shaped into round disks approximately 17.5 mm in radius and approximately 5 mm in thickness, or may be of any desirable shape or geometry for a particular application. A mould, in accordance with various embodiments, may be polished.

Non-limiting exemplary embodiments herein described may relate to the transfer of gratings to copper, silver, and aluminum of high purity (e.g. >99.99% purity).

In some embodiments, substrates may include any suitable material that may be embossed with finely structured features, and may further relate to other materials, metals, alloys, or the like, such as those that may be used to produce coins, serve as decorative pieces, employ anti-counterfeiting features, or the like. Substrate materials may, at some point during the processes and systems herein described, be approximately cylindrical in geometry, with diameters and heights of approximately 3 mm, although substrates are not limited to such materials, substrates, or geometries.

In accordance with various embodiments, moulds, or dies, may be fabricated using ultra-fast (e.g. femtosecond) laser machining techniques. Such moulds may enable the single-step replication of laser-engraved diffraction gratings on metals. While other means of producing moulds are encompassed in the scope of the disclosure, examples herein described may employ a laser source operating at a wavelength of approximately 515 nm, and a pulse length of approximately 300 fs with a laser repetition rate of approximately 200 kHz. A laser machining system may, in accordance with various embodiments, comprise a combination of a polarizing cube and half wave-plate, or another means of manipulating laser light polarization, with total laser energies tuned from 0 W to approximately 6 W. Various embodiments relate to pulse energies that may be calculated from the total energy and the repetition rate of a laser system. A microscope objective may, in accordance with some embodiments, be used to focus an incident laser beam onto a die surface. Various systems may enable control of line spacing with a precision of nanometers. Machining parameters, in accordance with some embodiments, may comprise a maximum speed of 100 mm/s, and a translation range of ±55 mm in both horizontal (X) and (Y) directions and ±2.5 mm in the vertical (Z) direction. The resolution of a stage may be approximately 1 nm, and the accuracy of the stage may be high enough to ensure the designed patterns are precisely produced. A chromatic point sensor (STIL, CL2-MG210) is used to acquire the surface profile of the die. The chromatic point sensor has a static noise (resolution) after averaging of 2.7 nm and a maximum linearity error (accuracy) of 55 nm. The profile data is sent to the controlling system for calibration, to ensure that the surface always stays in focus during machining. This is key to maintaining consistent machining quality when using extremely low laser powers (close to the ablation threshold of the material). The process of machining the die may require a relatively long machining time to provide the appropriate precision as the die will be used to emboss tens of thousands of samples.

Furthermore, some embodiments may relate to the machining of dies using low pulse energies (e.g. nanojoule energies), close to a material's ablation threshold. As such, a chromatic point sensor may be used to correct for changes in surface height to keep a laser focused on a sample surface throughout laser machining, in accordance with some aspects.

Treated surfaces may, in accordance with some embodiments, be characterized by AFM, SEM, or optical imaging to assess a (micro)morphology and/or geometry of surface features (e.g. grooves) and embossing transfer results. Various examples herein described relate to the imaging of optical effects with a digital camera, and diffraction efficiency may be characterized by, for instance, spectrometers.

In accordance with various embodiments, embossing may be performed by applying a compression force on a material with a controlled end tonnage and loading speed. For instance, a 100 kN load cell may be used to set and record an applied load during embossing. In some aspects, for embossing, a substrate may be placed in a holder that comprises two cylinders (e.g. steel cylinders), one of which may be hollow so as to accommodate insertion of the other, wherein the substrate may be placed therebetween during embossing to apply a uniform loading.

Die fabrication by laser machining, in accordance with various embodiments, may relate to various structural patterns that have a uniform spatial period (e.g. 2 μm), or may comprise a gradient in spatial period. To generate various gratings and/or embossed grating qualities, laser machining may employ total laser powers of approximately 3 mW to 7 mV, with a repetition rate of approximately 200 kHz, and a line speed of approximately 6 mm/s to 15 mm/s, in accordance with various embodiments. In some embodiments, the line speed may be varied to increase a distance between laser pulses, which may affect the smoothness and/or geometry of a resultant machined surface.

In accordance with various embodiments, laser machining may result in grids consisting of, for instance, grooves with widths ranging from ^{˜}700 nm to several micrometers (e.g. 2 μm), depths from 80 nm to 500 nm, and/or line spacing from 1 μm to 10 μm. Various embodiments relating to the use of a point sensor may enable a substantial portion or all of a die surface to be uniformly machined. Such features may be characterised, for instance, to determine optimal parameters to produce a substrate and/or surface feature groove edge, quality, and/or geometry, using optical or electron microscopy. Furthermore, diffraction efficiency may be characterised to, for instance, determine machining parameters that provide for intense and/or preferred optical effects.

In accordance with various embodiments, the parameters shown in the table 1 may be employed to provide grooves with a width of approximately 1 μm, a depth of approximately 450 nm, and a desirable edge smoothness with line spacing ranging between 2 μm to 4 μm with satisfactory optical effects.

TABLE 1

| | | Laser | | | |
|---|---|---|---|---|---|
| | Laser | repetition | Machining | Number of | Line |
| | power | rate | speed | passes | spacing |
| Values | 0.7 to 10 | 10, 30, | 3 to 15 | 1, 2, 4 | 1 to 10 |
| tested | (mW) | 200 (kHz) | (mm/s) | | (micron) |
| Main | Width and | Smoothness | Width and | Depth | Duty |
| effect | depth of | of the | depth of | of the | cycle |
| | grooves | groove edge | grooves | grooves | |
| Selected | 5 mW | 200 kHz | 9 mm/s | 1 | 2, 4 |
| parameters | | | | | |

Laser machined dies, in accordance with various embodiments, may be cleaned and/or polished in order to improve subsequent embossing. For instance, various embodiments relate to removal of debris from a die surface after machining by way of a wiping step. In at least one embodiment, wipes saturated with a colloidal silica suspension may be used to polish a machined surface for approximately 1 minute. Subsequent or alternative treatment may relate to placing a die under running water for a designated amount of time (e.g. 30 s) to remove any residual material (such as colloidal suspension, as in the abovementioned non-limiting example). Dies may, additionally or alternatively, be rinsed to varying degrees with other solutions such as ethanol, isopropyl alcohol, and the like, for instance to prevent oxidation, and then appropriately dried for use.

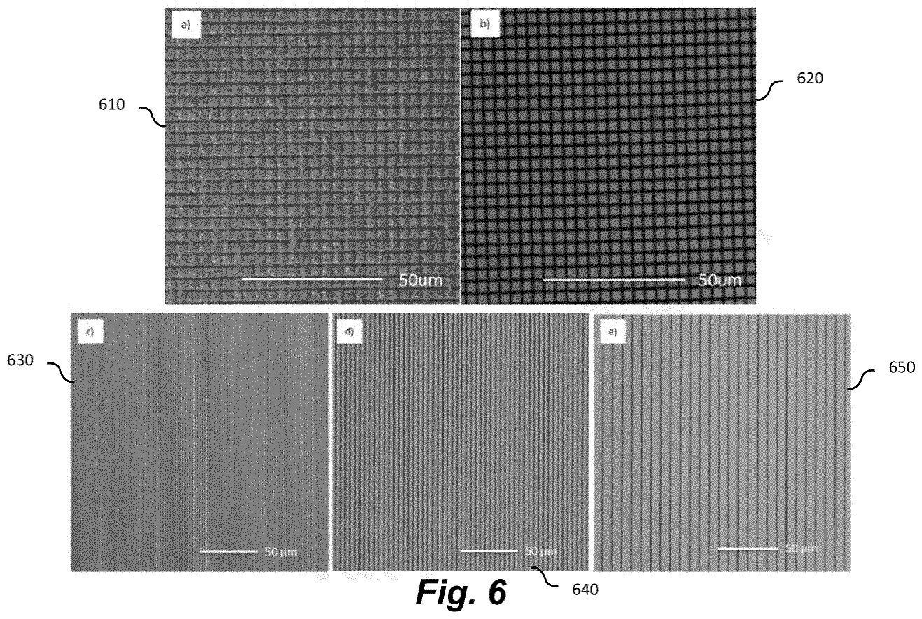

For instance, and in accordance with various embodiments, dies fabricated with the abovementioned polishing/cleaning protocol(s) are presented as optical images of laser machined surfaces in FIG. 6A to 6E. FIGS. 6A and 6B show, respectively, die surfaces with 4 μm line spacing in a two-dimensional arrangement (i.e. a grid) before 610 and after polishing 620. FIGS. 6C, 6D, and 6E, on the other hand, show, respectively, gratings with line spacing of 2 μm 630, 4 μm 640, and 8 μm 650, after a polishing procedure.

Various aspects of the disclosure relate to pre-flattening a substrate prior to embossment with a machined die, although a pre-flattening step is not required to enable the systems and methods herein disclosed. In such embodiments, substrate pellets (i.e. materials to be embossed) may be stamped with a fixed tonnage before embossing. For example, a substrate may be placed between two polished (i.e. flat) disks and stamped with a fixed tonnage. In accordance with various embodiments, such a pre-flattening procedure may aid in subsequent embossing by stamping the substrate to an appropriate geometry (e.g. thinning the substrate to achieve a designated diameter, such as 5 mm, or the diameter of a coin). Pre-flattening may additionally improve a quality and flatness of the substrate compared to typical pellets used for embossing, and may optionally preclude one or more polishing steps otherwise required prior to embossing. Furthermore, by controlling a pre-flattening stamping load, all substrate disks may have more uniform properties for reproducible and/or reliable embossing. That is, pre-flattening may render substrates to a more consistent pre-embossing condition. For instance, pre-flattening may produce substrates that have all undergone a similar extent of pre-embossing deformation and hardness, or confer thereto a similar uniform density.

Pre-flattening, in accordance with various embodiments, may perform much of the ultimate deformation required to emboss, for instance, coins, from a raw substrate. This may, in accordance with various embodiments, result in less deformation during an embossment stamping procedure, thereby improving the ultimate quality of embossing. For example, pre-flattening may minimise the amount of lateral deformation experienced by a substrate during embossing, and as such, may mitigate issues arising from the sensitivity of micro-scale embossing to the distribution and direction of applied load and/or the angle between embossed feature orientation and substrate flow during stamping. In accordance with various embodiments in which a substrate is pre-flattened, a designated load (or stress) may be applied to achieve a high degree of transfer efficiency for a particular material, and may vary based on a particular application or substrate. In accordance with various embodiments, a pre-flattening load applied to a substrate may be approximately 25 kN (^{˜}550 MPa) for silver and copper, or 12 kN (^{˜}270 MPa) for aluminum.

Existing methods and systems for embossing fine structures may be limited by microscale failure of a transfer, whereby a deformed portion of a substrate may remain stuck in a groove of a die, which is then pulled off of the substrate during unloading. In addition to producing a poor transfer quality in which a feature, such as a grating, is not effectively introduced to the substrate, this may preclude the re-use of the die for subsequent embossing and lead to very short die lifetimes. As such, overall transfer speeds may be reduced on the industrial scale using conventional stamping techniques and systems as dies need to be cleaned and/or replaced.

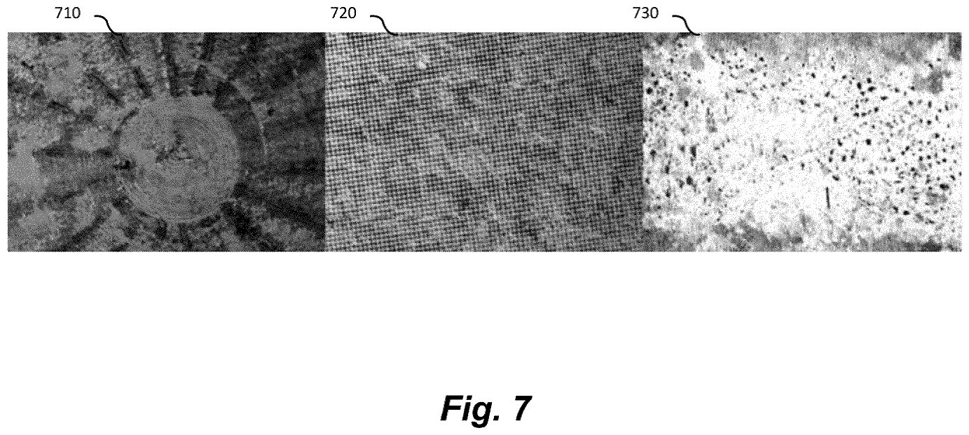

This phenomenon is illustrated in FIG. 7, wherein SEM images show copper adhesion to the surface of a die for grating patterns of an 18-sides wheel 710 a cross-hatched square grating 720, and a linear one-dimensional square grating 730. In accordance with some embodiments, such failure modes may be mitigated or precluded by, for instance, pre-flattening a substrate as described above. In other embodiments, feature patterns may be designed to produce grooves of an orientation that coincides with a desired or natural substrate flow direction during embossing. For instance, if substrate deformation during embossing is radially outward from the centre of a substrate, features may be designed to accommodate such outward material flow in order to produce a higher quality of transferred features, such as by designing radially extending grooves, ridges or like micro-scaled structures within the context of a radially displacing bulk substrate material during embossing.

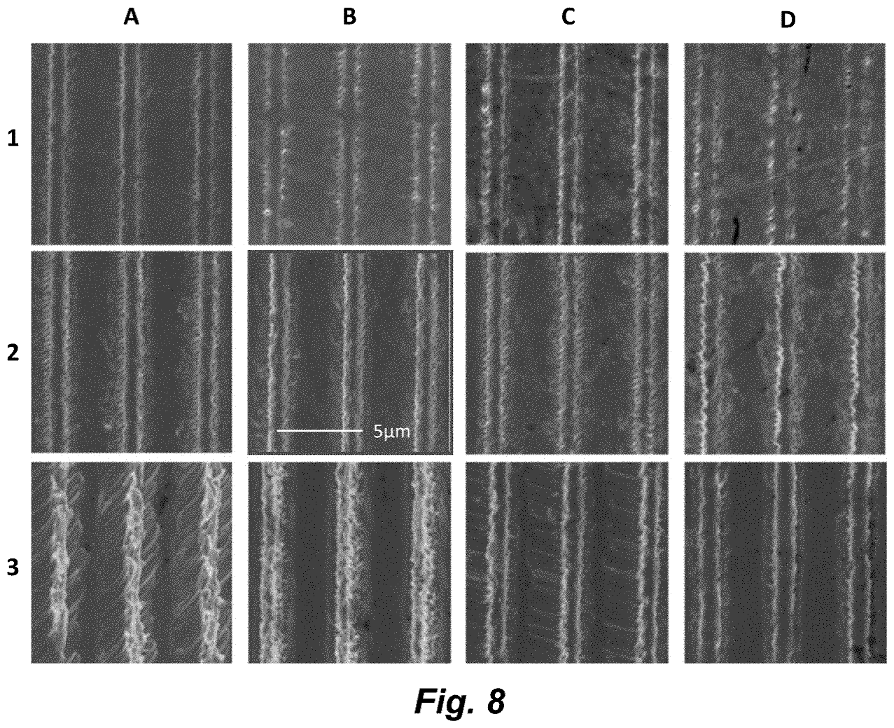

In accordance with various embodiments, laser machining and embossing parameters and procedures may be selected to mitigate effects of material failure of various substrates. This may increase reusability of die pieces, allowing for up to thousands of embossments or more at room temperature (also herein referred to as “cold” embossing). For instance, substrates of the same material embossed with the same load force may have grooves of different geometry, and thus have different filling and deformation behaviour during embossing, due to differences in laser machining. This is shown in FIG. 8, where SEM images of 1D linear gratings in the shape of 2 mm by 2 mm squares embossed on silver substrates using a die etched with different laser parameters are shown. In this example, and in accordance with various embodiments, numbered rows correspond to laser powers of 3 mW, 5 mW, and 7 mW for rows 1, 2, and 3, respectively, while columns A, B, C, and D correspond to, respectively, line speeds of 6 mm/s, 9 mm/s, 12 mm/s, and 15 mm/s.

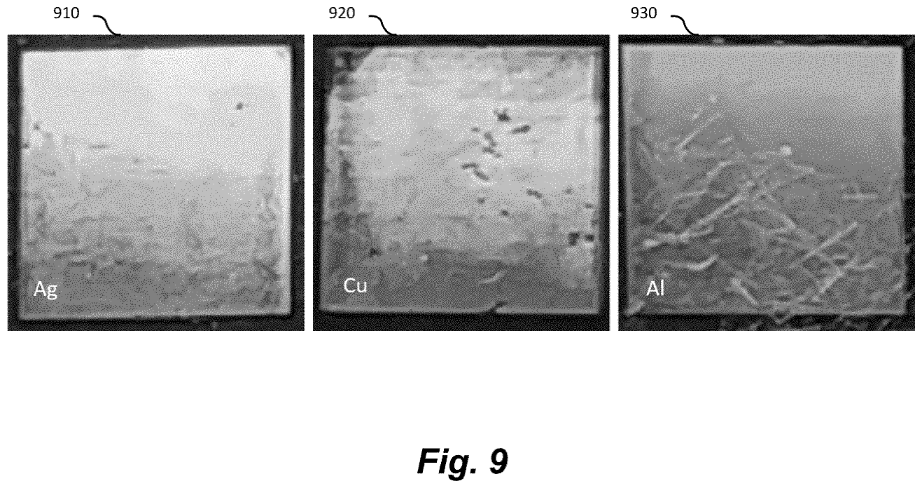

In accordance with various embodiments, parameter combinations, of which the results of non-limiting examples are shown in FIG. 8, may be selected for laser machining which result in, for instance, desired edge and/or surface smoothness for various substrates. FIG. 9 shows pictures of exemplary 1D square gratings embossed in silver 910, copper 920, and aluminum 930 with dies fabricated with desired parameters.

In accordance with various embodiments, laser machining parameters may also be selected based on a resultant diffraction efficiency, for instance via measurement with a spectrometer, the means by which this may be accomplished will be appreciated by the skilled artisan.

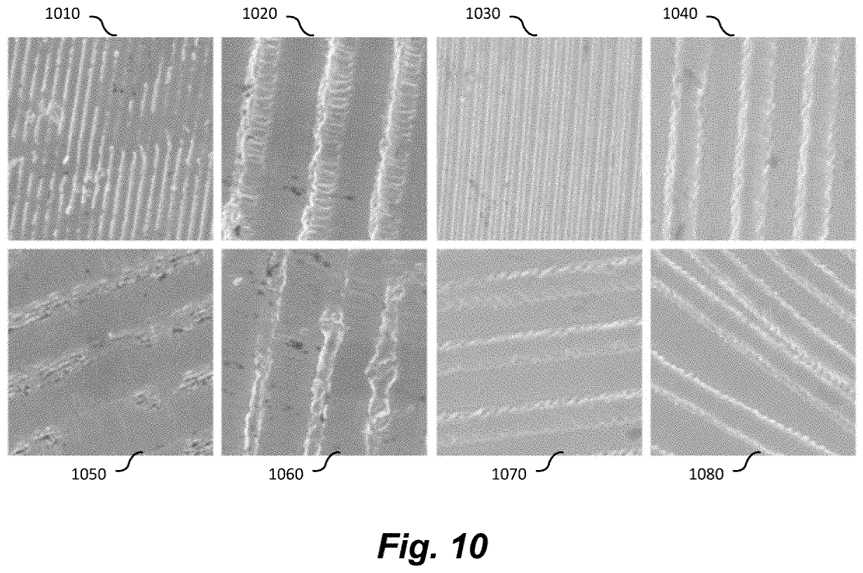

Embossment quality may, in accordance with various embodiments, be affected by laser light polarisation used in die fabrication. For example, different groove morphologies may be observed in embossed substrates from grating moulds oriented at various angles from the direction of stage movement during machining. Furthermore, in some embodiments, the effects of light polarisation may be a function of feature orientation in the embossed substrate. For instance, FIG. 10 shows SEM images 1010-1080 of silver substrates embossed with die gratings oriented in different directions and made from different light polarisations. In this example, images 1010, 1020, 1030, 1040 show SEM images of the general transfer quality and grooves at different orientations prior to adding a quarter wave plate in the laser beam path. Images 1050-1080, on the other hand, show various orientations of gratings formed by a die fabricated using laser light circularly polarised by inserting a quarter-wave plate in the beam path.

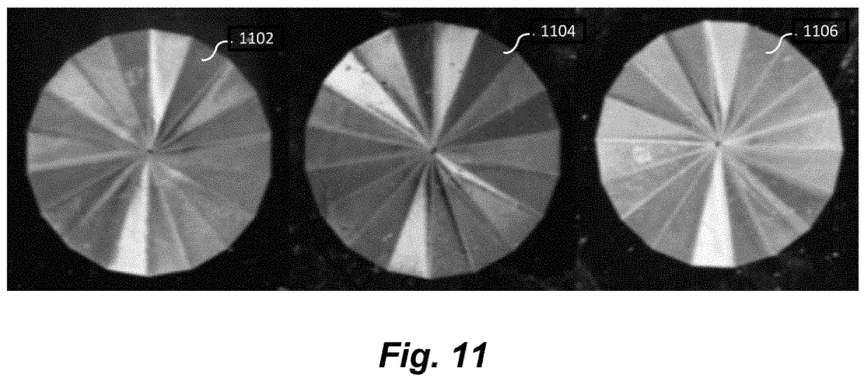

In the above-mentioned example, and in accordance with various embodiments, the use of circularly polarised light may thus improve embossing by, for instance, mitigating the effect of feature orientation relative to stage movement for light with various polarisations. Pictures of the patterns partially shown in images 1010-1080 embossed into silver 1102, copper 1104, and aluminum 1106 using dies fabricated with optimised machining parameters are shown, from left to right, in FIG. 11.

In accordance with various embodiments, a substrate, or pre-flattened substrate, may be embossed by placing the substrate between an engraved die and a smooth polished die. Various embossing loads and speeds may be used in various embodiments, and may be designated based on the desired optical effect. In some embodiments, a surface die may be larger than an embossed substrate, and/or allow for multiple gratings to be machined on a single die. In accordance with various embodiments, various features may be engraved on a die at various angles relative to an orientation of a substrate or die (e.g. parallel or perpendicular to the radius of a resultant coin or the stamp die). This may, for instance, improve transfer quality by mitigating negative effects of material flow during embossing.

Ductility and/or hardness of a substrate, which may be affected by a pre-flattening step as described above, may ultimately affect embossment quality. As such, and in accordance with various embodiments, a heat treatment (annealing) step may be employed to alter a substrate ductility, whether or not a substrate has been pre-flattened.

For instance, heat treatment parameters and relevant substrate hardness values before and after treatment, in accordance with various embodiments, are shown in Table 2.

TABLE 2

| | | | | Hardness | Hardness |
|---|---|---|---|---|---|
| | | | | before | after |
| | | | | annealing | annealing |
| Material | Temperature | Time | Cooling | [HV] | [HV] |
| Silver | 600° C. | 90 min | Natural | 101.47 | 27.66 |
| Copper | 550° C. | 60 min | Natural | 134.92 | 41.75 |
| Aluminum | 350° C. | 60 min | Natural | 33.79 | 18.90 |

In accordance with various embodiments, transfer quality, as reflected by, for instance, edge smoothness of transferred ridges and diffraction efficiency, may be affected by applying various embossing loads. Furthermore, the selection of an appropriate tonnage for embossing may influence the degree of deformation of a substrate, for instance by minimising deformation in the direction of the place perpendicular to the loading direction. Moreover, reduction of shear on a filled material may reduce tarnishing of a die.

A certain amount of metal flow is necessary for the substrate material to fill in the laser machined grooves on the die. The filling height of the grooves is positively correlated to the amount of metal flow. Excessive metal flow/filling height could cause a dramatic increase in the friction and lead to substrate failure. The angle between the metal flow direction and the groove orientation can affect the metal deformation and therefore the transfer quality. The grooves along the radial direction (parallel to the metal flow) are preferred when making designs.

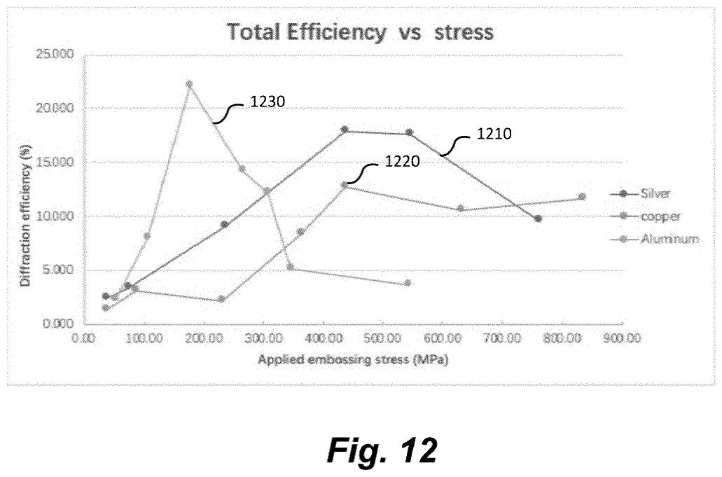

For instance, as shown in FIG. 12, the embossing loads, in accordance with various embodiments, may be varied to improve embossing quality. For a given substrate material and/or application, too small of a load may not fully transfer features. For example, insufficient tonnage may result in an incomplete transfer if, for instance, the material to be embossed does not sufficiently fill a die. Conversely, too high of a load may result in the failure of a sample (e.g. substrate material may fill a die groove and be removed by a die, whereby a die may then be less utile in subsequent embossments). Various embodiments may further relate to a critical load (stress), or, alternatively or additionally, to an optimal load required to obtain a desired grating efficiency for a given material or application.

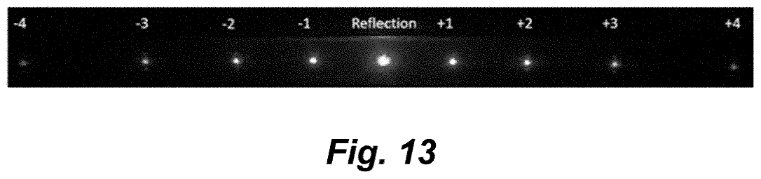

For instance, as shown in FIG. 12, the total diffraction efficiency of embossed silver 1210, copper 1220, and aluminum 1230 substrates as a function of embossing stress. In these non-limiting examples, a helium-neon laser was used as an illumination source, and the diffraction patterns of the substrates examined comprised a series of dots arranged in a line perpendicular to a groove orientation as shown in FIG. 13.

Total laser power incident on the substrate was measured by placing a power meter immediately in front of the substrate. In these examples, 12 diffraction orders were observed from −6 to −1 and +1 to +6, but diffraction orders of ±1, ±2 were used in total power calculation and diffraction efficiency due to the negligible contributions of higher orders.

In accordance with various embodiments, an embossing load may be set to values smaller than a pre-flattening tonnage described above. However, various substrates and/or applications may not require a pre-flattening of a substrate, or may benefit from pre-flattening loads that are less than an embossing load. Various non-limiting exemplary embossing parameters, in accordance with various embodiments, are listed in the following table. Further embodiments relate to the embossment of silver, copper, or aluminum with embossing loads of, respectively, ^{˜}20 kN (430 MPa), ^{˜}20 kN (430 MPa), and ^{˜}8 kN (180 MPa).

| | | Pre-flattening | | Embossing |
|---|---|---|---|---|
| | Pre-flattening | loading rate | Embossing | loading rate |
| Substrate | load (kN) | (mm/min) | load (kN) | (mm/min) |
| Silver | 25 | 2 | 18/20/22 | 1 |
| Copper | 25 | 2 | 16/18/20 | 1 |
| Aluminum | 12 | 1 | 6/8/10 | 0.5 |

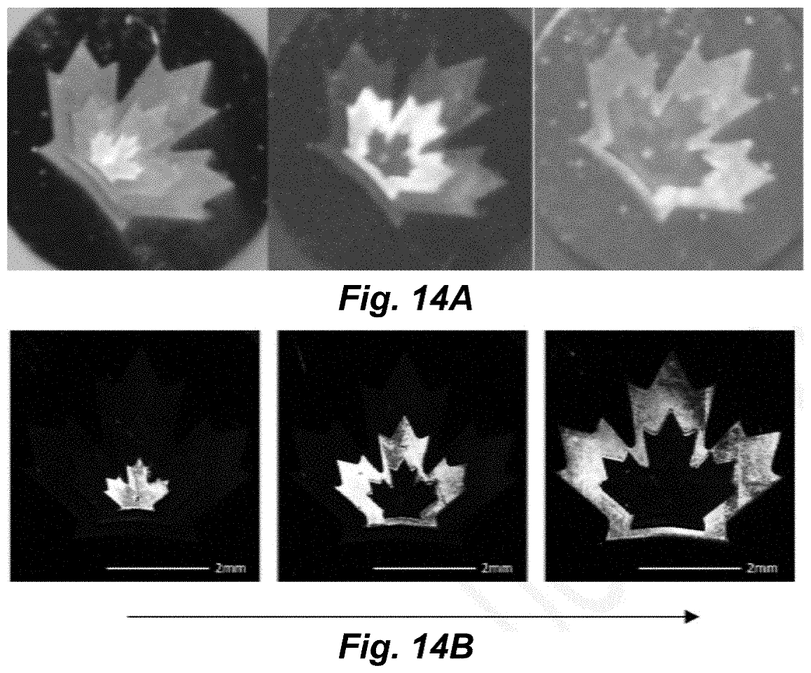

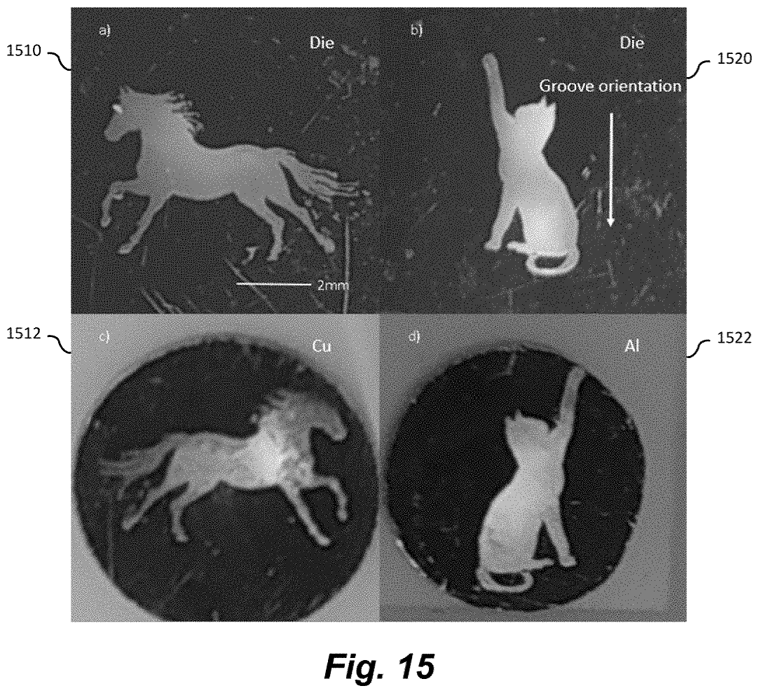

Various embodiments relate to the reliable and reproducible transfer, many times using an embossing die, of overt features and/or shape-shifting patterns. For instance, FIG. 14A shows a silver substrate embossed with three differently sized leaf patterns which comprise grooves, line spacing, of different respective orientations. In this example, and in accordance with various embodiments, diffraction coupling may occur when light is incident on the substrate from a designated angle with respect to groove orientation, resulting in a visual effect where the patterns appears to shift when the sample is rotated, as it is, from left to right, in FIG. 14A. FIG. 14B also illustrates this effect as the angle of incident light is changed, wherein each image panel from left to right exhibits the optical effect on patterns corresponding to increasing leaf sizes.

Other examples of arbitrary patterns embossed on a metal substrate by way of the systems and methods herein disclosed are shown in the images of FIG. 15, wherein pictures of a horse 1510 and a cat 1520 were machined and embossed on copper 1512 and aluminum 1522 substrates, respectively. In this example, the embossed shapes were approximately 5 mm by 5 mm, and fine tips and small sections of the pictures are clearly transferred.

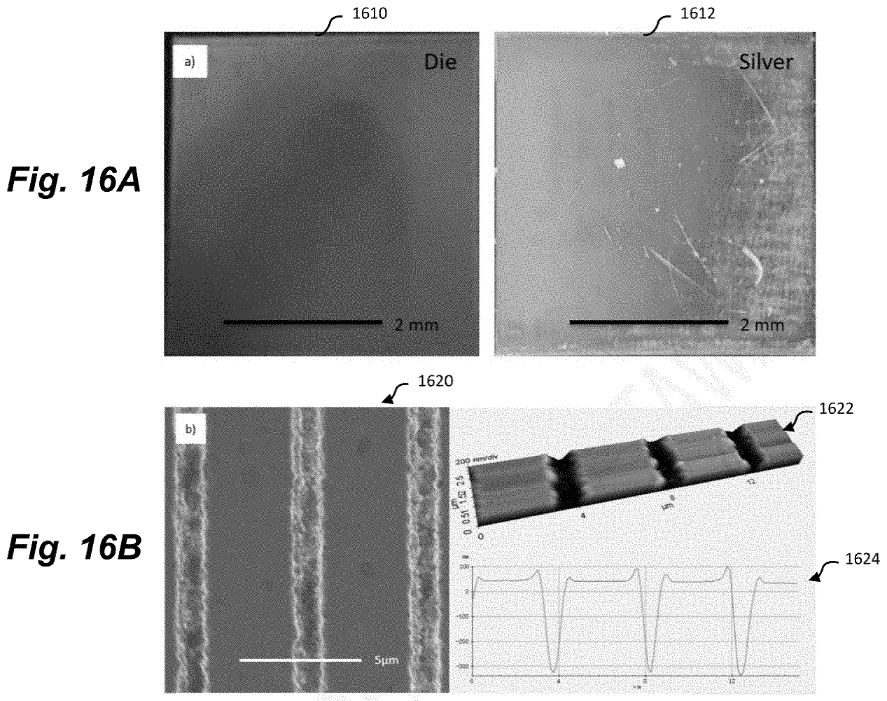

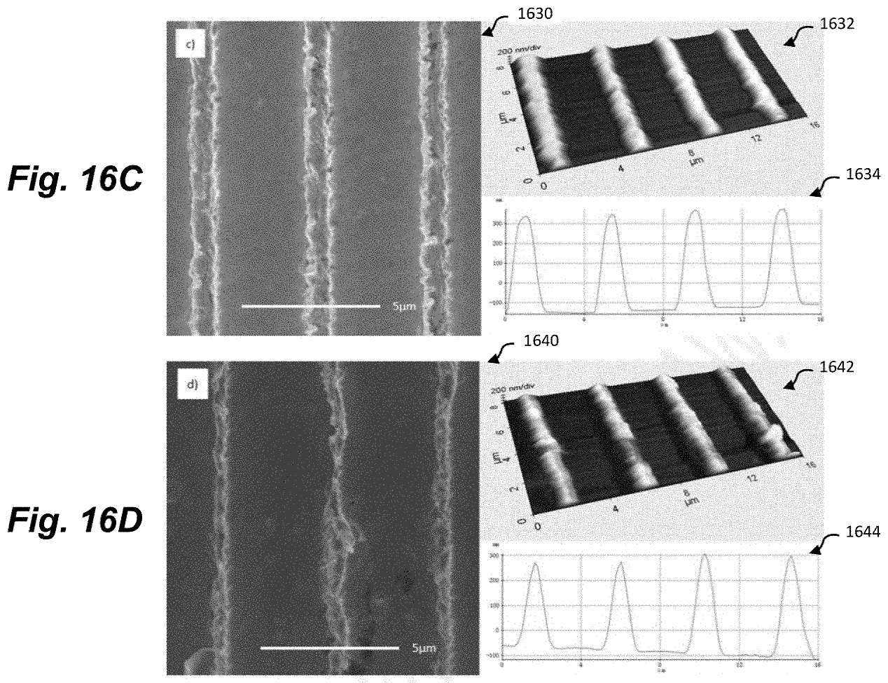

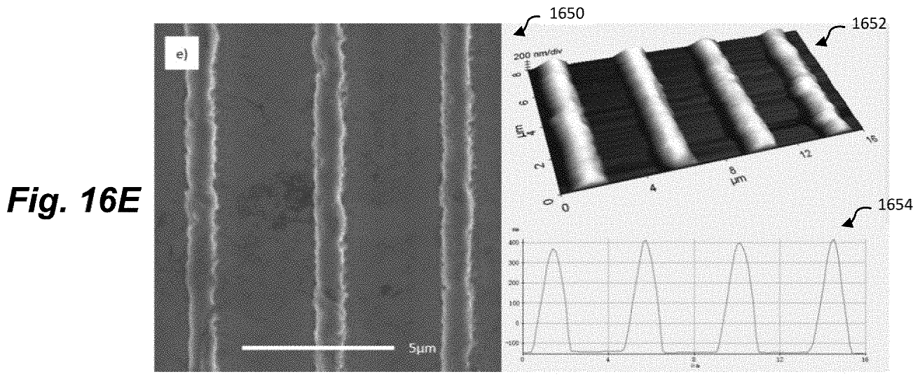

Various examples of a die with a one-dimensional square grating array, and substrates therewith embossed, are shown, in accordance with various embodiments, in FIGS. 16A to 16E. FIG. 16A shows, on the left and right, respectively, optical microscopy images of a die 1610 and a silver 1612 substrate embossed therewith. FIGS. 16B to 16E show on the left 1620, upper right 1622, and lower right panels 1624, respectively, scanning electron microscope (SEM) images, atomic force microscopy (AFM) images, and averaged line scans of a die. FIG. 16B shows silver SEM 1630, AFM 1632, averaged line scans of die 1634. FIG. 16C shows copper SEM 1640, AFM 1642, averaged line scans of die 1644. FIG. 16D shows aluminum SEM 1640, AFM 1642, averaged line scans of die 1644 and FIG. 16E shows substrates embossed with the die of FIG. 16B SEM 1650, AFM 1652, averaged line scans 1654.

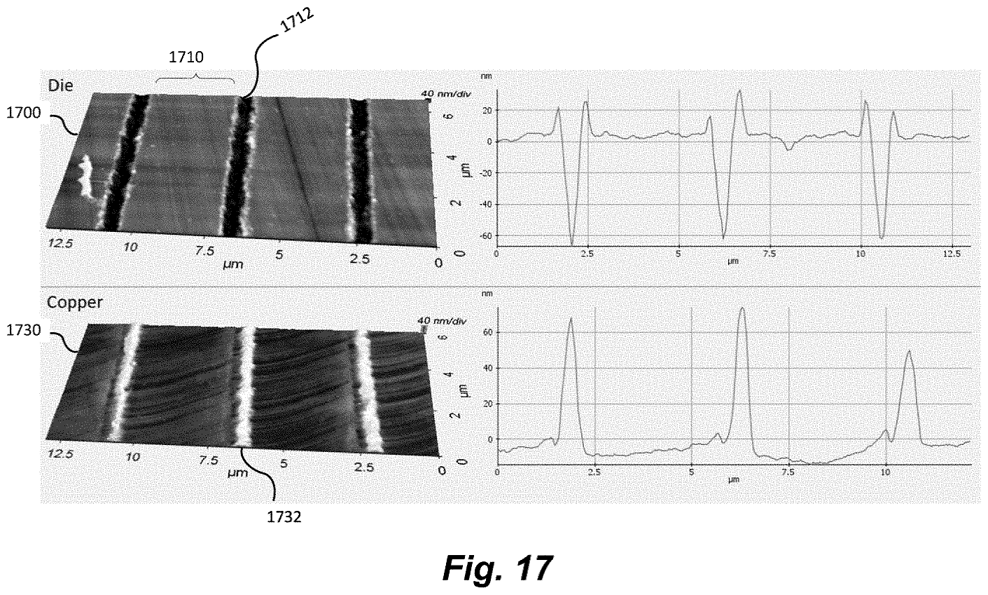

Various embodiments may further relate to the fabrication of dies and/or the subsequent embossing of substrates with sub-micron features. For instance, and in accordance with at least one aspect, FIG. 17 shows an AFM image of a die 1700 and corresponding averaged line scan 1720 of a feature transferred to a copper 1730 substrate. In this non-limiting example, the line spacing period 1710 is approximately 1 μm, and the size of each groove 1712 is approximately 700 nm generating corresponding feature 1732. Laser machining parameters used in making this die, in accordance with various embodiments, are a total laser power of 1.5 mW, a repetition rate of 200 kHz, a pulse energy of 7.5 nJ, and a line speed of 3 mm/s.

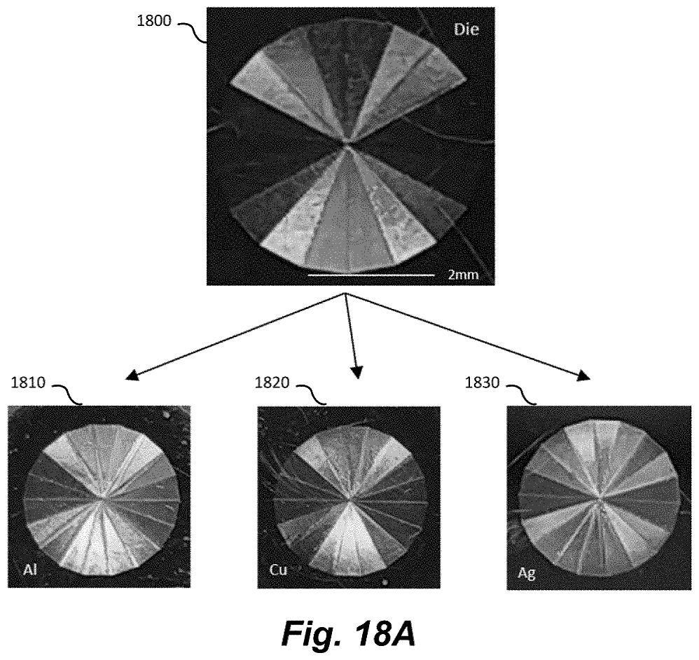

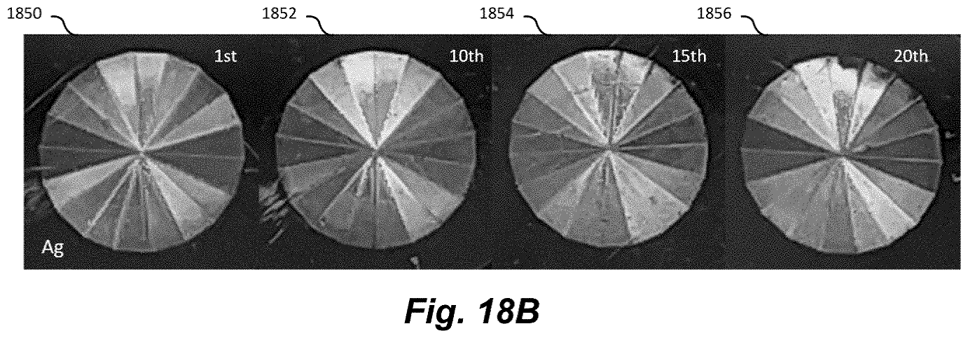

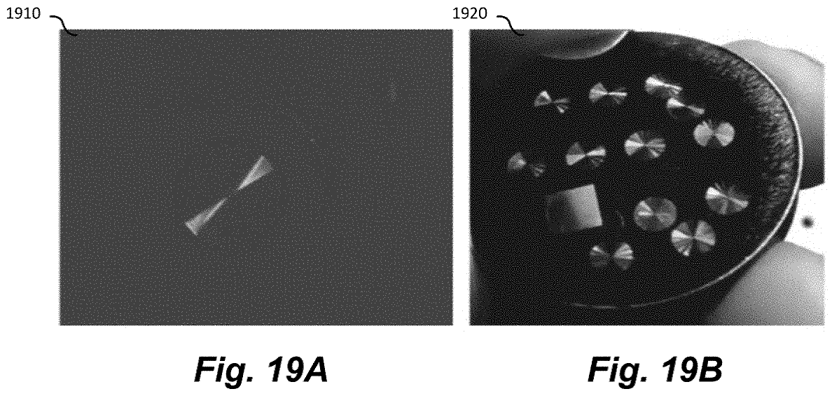

Various nano-, micro- and macro-scale features may be machined and embossed, in accordance with various embodiments. For instance, macroscopic patterns comprising microscopic gratings may be transferred during embossing. FIG. 18A shows an example of one such pattern, herein referred to as an 18-sides wheel, which may be machined homogenously to produce various colorful effects. In this example, an 18-sides wheel is machined into a steel die 1800, which was then used to transfer the pattern via embossing to aluminum 1810, silver 1820, and copper 1830. As shown in FIG. 18B, the embossing of silver was repeated 20 times (1st 1850, 10th 1852, 15th 1854, 20th 1856) to show the high reproducibility of the transfer quality. The colorful effects, and thus quality of the machining and transfer process, is further highlighted in FIGS. 19A and 19B, where the shifting fans of a single 18-sides wheel 1920 and the shimmering effect of a group of 18-sides wheels 1930 are shown.

While the abovementioned embossments may be readily visible, or overt, to a viewer, various embodiments may further relate to methods and systems of embossing that may be more covert in nature. For instance, while the high-quality transfer of the abovementioned embodiments may serve as an anti-counterfeiting measure in, for instance, currency manufacture, so too might covert embossments that are less readily visible to the naked eye and/or in ambient lighting conditions. For instance, methods and systems for creating covert security features based, at least in part, on the arranging of resultant diffraction order positions and/or angles from micro-grating pixels are also within the scope of the disclosure.

As the gratings may be designed and embossed to diffract specific wavelengths of light in specific directions, as discussed above, patterns may further be employed to diffract specific diffraction order points precisely projected at designated positions and/or angles. For instance, when a one-dimensional grating is illuminated with a laser beam, diffraction orders may be distributed to both sides thereof and in the same plane as the incident beam. Diffraction orders may then be captured using, for instance, a screen oriented parallel to the grating surface. In such a fashion, diffraction orders projected on the screen may lie on a line that is perpendicular to the grating grooves, wherein the line may be rotated according to the rotation of the grating itself. Furthermore, the distance to each diffractive order from the center of the screen may be controlled by the spatial period of the grating. In the examples shown in the figures only the symmetric patterns, such as the star and the square as the designs were made based on normal incidence of the beam. The described technology can also be used to produce diffraction patterns that are asymmetric by changing the incident angle of the illumination.

As such, the position of a diffraction order (e.g. m=±1) can be designed and precisely controlled using, for instance, the abovementioned laser machining protocols. By reducing the size of the entire grating down to the microscale, and in accordance with various embodiments, it is feasible to arrange hundreds of diffractive gratings within a small area, such as that corresponding to a coin.

A non-limiting example of laser parameters that can be used to machine such patterns may comprise a laser power of approximately 2 mW, and a line speed (machining speed) of approximately 0.1 mm/s to 0.2 mm/s.

In some embodiments, a digital computer-executable program may be implemented for calculating the spatial period and the orientation of a micro-grating or array thereof, for instance to designate a particular diffraction order position(s) or angle(s) that may, for instance, be captured using a screen or other means of detecting diffracted light.

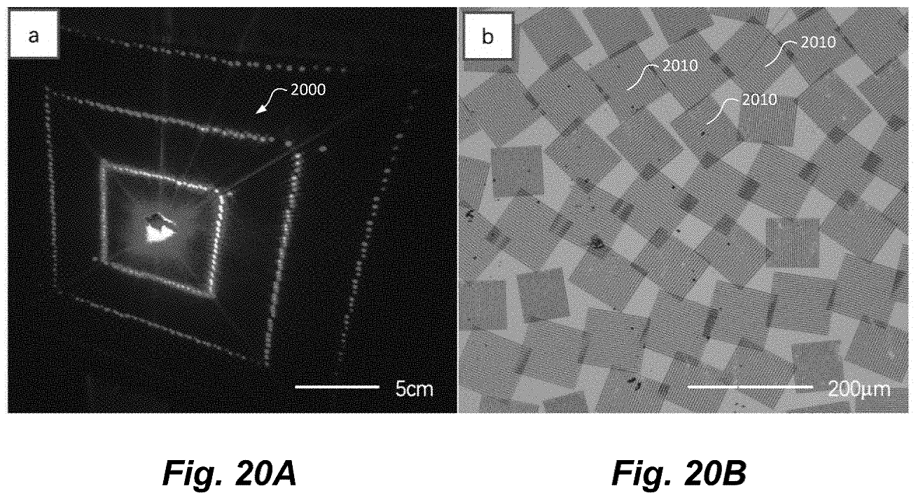

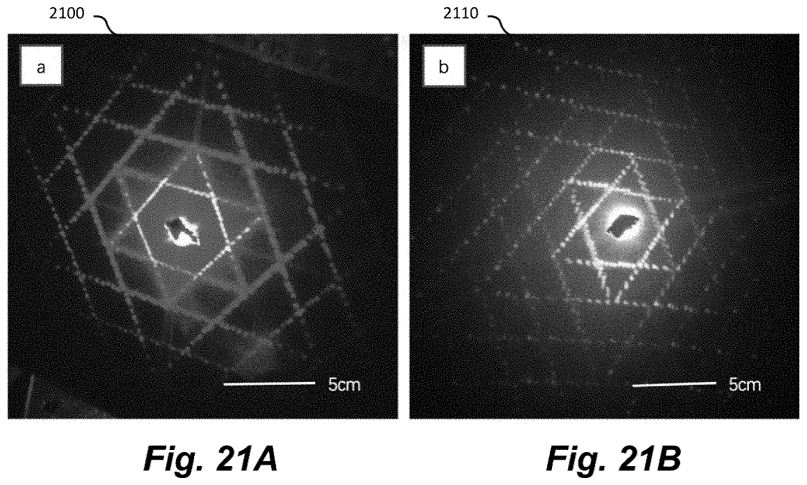

Non-limiting examples of such embodiments are shown in FIGS. 20A, 20B, 21A, and 21B. FIG. 20A, for instance, shows the diffraction pattern 2000 produced by the diffraction gratings partially shown in FIG. 20B. In this example, a square pattern is produced from 90 gratings 2010 of a designated spatial period and orientation. In this example, the size of each grating shown in FIG. 20B is approximately 0.01 mm2, and gratings are machined on a surface area of approximately 1 mm by 1 mm (^{˜}1 mm2).

FIG. 21A, on the other hand, shows a star-like diffraction pattern 2100 resulting from light diffracted by a laser-machined die comprising 144 micro-gratings, in accordance with various embodiments. The die from FIG. 21A was then used to emboss a silver substrate, in accordance with various embodiments, and the diffraction pattern 2110 resulting from light incident thereon is shown in FIG. 21B. In this non-limiting example, the entire machined surface and resulting features occupy a surface area of approximately 1.5 mm by 1.5 mm.

Furthermore, and in accordance with various embodiments, transfer of patterns from a die to substrate may improve diffraction pattern quality. For instance, it can be seen that while the die's pattern 2100 of FIG. 21A comprises bright spots corresponding to orders of up to ±3, those related to the substrate in FIG. 21B are more evenly distributed 2110, with orders of ±4 or more clearly observed.

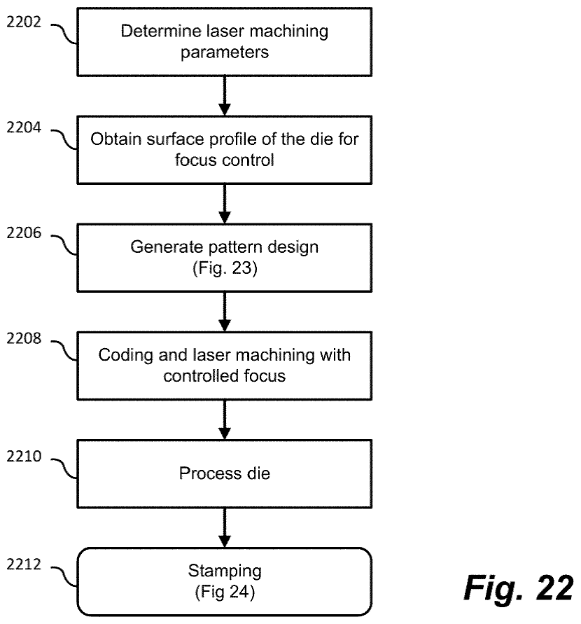

FIG. 22 shows a method of embossing micro-scaled surface features. Laser machining parameters are determined (2202). The surface profile of the die is obtained (2204) for focus control of the laser during engraving by scanning the die profile with the point sensor. The calibration between the point sensor and laser that was determined to adjust the surface profile for matching to the laser focus. The design that is to be applied to the die is used to generate the pattern design using the coding profile and the desired visual effects created by the gratings (2206). The laser machining and embossing technology can also be applied on coated dies with appropriate modification to laser parameters. The generated pattern is then utilized to code the laser focus control during the machining process. The die can then be engraved on the substrate using the parameters to create the finished die (2210). Stamping can then be performed using the created die (2212). Smoother grooves result in less adhesion between the die and the substrate during embossing which allows for a better transfer. After engraving redeposited material, in form of large debris, nanoparticles, and thin film, has different mechanical properties from the die itself, and its roughness is non-uniform. Also, at the edges of laser machined grooves, there are usually small bumps forming. A polishing procedure can be performed to remove the oxide layer and smoothen the grooves, which is important to obtain clean transfers and to reduce the chances of substrate failure (adhesion).

The main controlled laser parameters are laser power, laser polarization, machining speed, line spacing and number of passes. The minimum size of the possible laser machined feature is related to the size of the laser spot. On top of that, since the laser machining ablates the material by thermal activation, the applied laser machining power and machining speed decide the overall laser fluence, which determines the width and the depth of the machined grooves. Laser machining multiple passes could increase the depth of the machined grooves and also smoothen the grooves. The selected laser machining power and speed are found through laser machining trials. The line spacing have a slight affect on the machining quality due to the redeposition of the material (too much debris can cause varied machining results). When making designs, the line spacing is mainly decided by the desired optical effects (the observed colour at a certain angle).

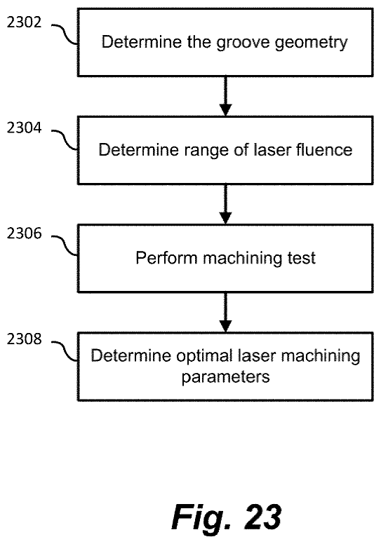

FIG. 23 shows a method of determining laser machining parameters. The design that is to be applied to the die is received. From the design, groove geometry required to create specific optical effects, catalytic properties, physical or chemical properties and surface functionalization is determined (2302). The groove geometry is determined based upon the die substrate and the embossing material for achieving good optical effects. For example if the line spacing should be between 2 to 4 microns, then the groove size would be around 1 to 2 micron, and the depth/width can affect the diffraction efficiency. The range of laser fluence is determined (2304). The size of the laser spot affects the groove geometry directly. If the desired groove width is obviously larger than the spot size, then using high fluence is required. If the groove size is close to the spot size, using medium fluence is required. If the grooves size is similar to the spot size and requires laser machining close to the threshold, using low fluence is required. The design can be tested (2306) utilizing a range of power and speeds to determine optimal results and the associated laser machining parameters (2308).

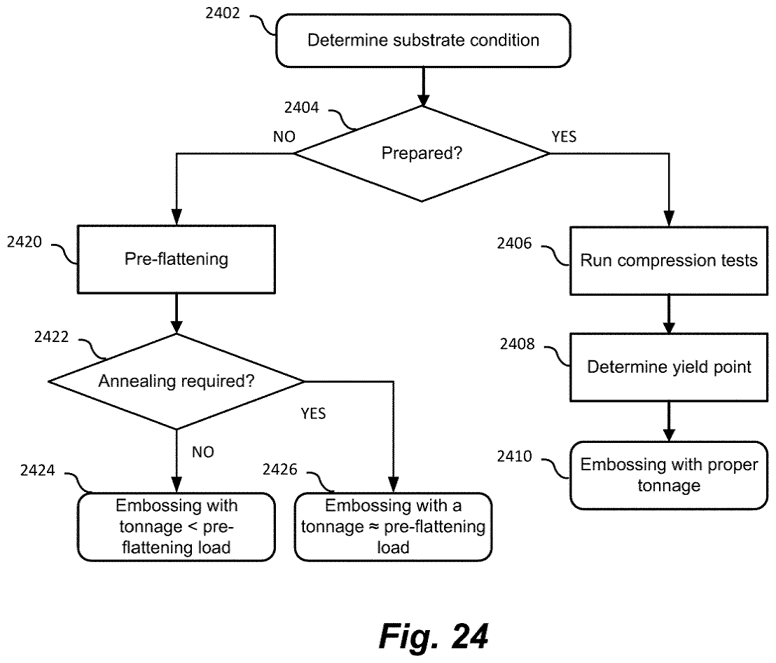

FIG. 24 shows a method of determining embossing parameters. The initial condition of the substrate material used for embossing is determined (2402). If the initial material is polished and sized for the embossing process (YES at 2404), a compression test on substrate material can be performed (2406) to determine a yield point (2408) for the material for determining proper tonnage required to provide the desired visual effect from the configured die. Embossing can then be performed using the proper tonnage (2410) for the substrate material, usually close to and slightly smaller than the yield stress obtained in the previous step. If the substrate is not prepared (NO at 2404), pre-flattening can be performed with a blank die (2420). Pre-flattening can be used as a quick method of preparing circular substrate materials. The difference between pre-flattening and embossing is that a pre-flattened substrate should have a much larger initial thickness (height), which assures that the material experiences a large plastic deformation during pre-flattening and thus becomes uniform and hard. By stamping the substrate material with blank dies, the surface smoothness of the material will be improved to a similar level as that of the die, which is helpful to obtain a shiny surface and bright structural colors. By doing pre-flattening, the mechanical properties of the substrate material can be revealed. If the applied pre-flattening load is not high enough, the substrate surface will not be smooth enough. While if the pre-flattening load is too high, the die surface will be damaged even if it has very high hardness and toughness, especially when it is used for multiple trials. With a proper pre-flattening load, one can predict a proper embossing tonnage. If the material is pre-flattened with a certain tonnage, then it can be embossed with a tonnage at 60 to 80 percent of the pre-flattening tonnage (depending on the groove geometry) without adhesion. The annealing of the substrate will allow a larger window around the pre-flattening tonnage to obtain successful transfer.

If annealing is required (YES at 2422) the embossing can be performed with tonnage that is close to the determined pre-flattening load (2426). If annealing is not required (NO at 2422), embossing with tonnage less than the pre-flattening load is utilized (2424). Smaller groove size and higher line density (smaller line spacing) requires lower embossing tonnage to transfer the feature without adhesion.

If the substrate material is not prepared by pre-flattening, then it would be necessary to run some compression tests using blank dies to obtain the yield point of the material. When doing embossing, the applied tonnage should be slightly less than the yield point if the material is not constrained.

Furthermore, the systems and methods herein disclosed may be employed in ambient conditions. For example, while existing embossing methods may require elevated temperature in order to transfer small features reliably, aspects related to the disclosure may enable embossing of such patterns at room temperature.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, workpiece, and fabrication material detail may be made, without departing from the spirit and scope of the present disclosure, as set forth in the appended claims, as may be apparent to those of ordinary skill in the art, are also encompassed by the disclosure.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-24 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

1. A method of fast replication of laser machined micron/sub-micron scale patterns onto soft-metal substrates via embossing comprising:
laser machining of a die to engrave grooves;
pre-flattening of the substrate using two blank dies with a pre-flattening load; and
embossing of the substrate using the laser machined die and a blank die with an embossing load.

2. The method of claim 1 further comprising preparing the substrate by pre-flattening by applying a load that deforms material of the substrate to obtain desired thickness and size and improve surface smoothness.

3. The method of claim 1 further comprising determining a proper embossing load at about 10 to 30 percent less than the pre-flattening load, depending on material of the substrate and the scale of the patterns.

4. The method of claim 1 further comprising
determining laser machining parameters associated with a laser for embossing a material and a composition of a die material;
obtaining a surface profile of the die material;
generating a pattern design for application to the die material applying the obtained surface profile; and
laser machining the die material with the generated pattern design.

5. The method of claim 1 further comprising processing the die to removed redeposited material.

6. The method of claim 1 further comprising embossing of metal with the die.

7. The method of claim 1 wherein obtaining a surface profile a point sensor is utilized to map a profile of the die.

8. The method of claim 7 wherein a displacement in a x-axis and y-axis between the point sensor and the laser are determined to calibrate the surface profile.

9. The method of claim 1 wherein determining laser machining parameters further comprises:
determining a groove geometry associated with a pattern design;
determining a range of laser fluence;
performing a machining test using the determine parameters; and
determining optimal laser machining parameters from the machining test.

10. The method of claim 1 wherein a surface profile is obtained in a z-axis.

11. A system comprising:
a laser;
a point sensor;
a computer numerical control (CNC) motion-controlled platform coupling the laser and point sensor; and
a controller coupled to the laser, point sensor and CNC platform, the controller performing:
laser machining of a die to engrave grooves; and
embossing of a substrate using the laser machined die and a blank die with an embossing load subsequent to pre-flattening of the substrate using two blank dies with a pre-flattening load.

12. The system of claim 11 further comprising preparing the substrate by pre-flattening by applying a load that deforms a material of the substrate to obtain desired thickness and size and improve surface smoothness.

13. The system of claim 11 further comprising determining a proper embossing load at about 10 to 30 percent less than the pre-flattening load, depending on a material of the substrate and scale of patterns.

14. The system of claim 11 wherein the controller further performing:
determining laser machining parameters associated with a laser for embossing a material and a composition of the die;
obtaining a surface profile of the die;
generating a pattern design for application to the die applying the obtained surface profile; and
laser machining the die with the generated pattern design.

15. The system of claim 11 further comprising embossing of metal with the die.

16. The system of claim 11 wherein obtaining a surface profile a point sensor is utilized to map a profile of the die.

17. The system of claim 16 wherein a displacement in a x-axis and y-axis between the point sensor and the laser are determined to calibrate the surface profile.

18. The system of claim 11 wherein determining laser machining parameters further comprises:
determining a groove geometry associated with a pattern design;
determining a range of laser fluence;
performing a machining test using the determine parameters; and
determining optimal laser machining parameters from the machining test.

19. The system of claim 11 wherein a surface profile is obtained in a z-axis.

20. A non-transitory computer readable memory containing instructions for manufacturing a die containing micro-scaled features, the instructions when executed by a processor perform:
laser machining of the die to engrave grooves;
pre-flattening of the substrate using two blank dies with a pre-flattening load; and
embossing of the substrate using the laser machined die and a blank die with an embossing load.
